(19) United States
(12) Patent Application Publication
(10) Pub. No.: US 2011/0278252 A1
(43) Pub. Date: Nov. 17, 2011

(54) CRANE AND COUNTERWEIGHT CONTROL PROCESS OF A CRANE IN REAL TIME

(76) Inventors: Vinicius De Carvalho Cal, Salvador (BR); Rafael Guimarães De Lima E Silva, Salvador (BR)

(21) Appl. No.: 13/025,672

(22) Filed: Feb. 11, 2011

(30) Foreign Application Priority Data
Feb. 11, 2010 (BR) PI 1001193-5

(51) Int. Cl. B66C 13/18; B66C 23/72; G06F 19/00; B66C 23/02

(52) U.S. Cl. 212/279; 701/50

(57) ABSTRACT

This summary refers to an invention patent for a crane and counterweight control system belonging to the load movement equipment field, this crane essentially consists of: a tower (1); horizontal jib (10) assembled near the top of the tower (1); a distribution trolley system (20) assembled on a jib (10); load “C” assembled on a trolley (22) of the trolley distributor (20); a horizontal counterjib (30) assembled high up on the tower (1), opposite the jib (20) [NT 10?]; a counterweight (31) on the counterjib (30); this counterweight is a mobile counterweight (31), assembled on the respective trolley system (32) assembled on the counterjib (30) and this can move in toward or away from the tower (1) in function of the weight and position of load “C” in relation to the tower (1) and by an automation system (60) which implements a counterweight control process on a crane in real time, which controls the mobile counterweight movement (31) on the counterjib (30) in function of the weight and position of load “C” on the jib (10), seeking to cancel the total resulting momentum on the tower by the movement of load “C”.

This descriptive report refers to an invention patent for a universal tower crane, a crane, and the counterweight control process of a crane in real time for which original construction and solutions were given, seeking to improve the use, efficiency and safety of the crane in relation to similar existing ones. Crane-towers are already known, essentially consisting of: a tower; a jib extended from the tower top and along which moves a trolley, from which the load is hoisted and which moves along the jib; and a counterjib, which supports a ballast system or fixed counterweights, responsible for balancing the momentum generated by the load.

In spite of the wide use of this crane type, some problems can be attributed, for example the high incidence of accidents, due to the fact that the fixed counterweight cannot cancel or reduce in an efficient way the momentum generated by the load, so that the tower has to support/resist great forces during loading. Another influence of the fixed counterweight are the variable forces, mainly on its base and mast during loading, these variable forces cause fatigue on the materials which make up the tower, reducing the working life of the crane.

Another problem with normal cranes is the low load limit that can be operated, due to the same reason mentioned earlier, where the counterweight cannot cancel or reduce in a desirable way the momentum generated by the load, due to the weight being a contributing factor to the momentum.

Another factor which limits the use and construction with cranes is the tower height, because this height is also determined by the total momentum, which is the subtraction of the momentum generated by the load with the counterweight, because this momentum generated at the tower top will generate another momentum which will be directly proportional with the tower height.

So, the objective of this patent is to provide an improved crane which overcomes the problems referred to above found in the usual types.

Another objective is to provide an improved crane which besides overcoming the problem presented it can overcome the problem by a simple construction and production method and a relatively low cost in view of the crane cost.

Another objective is to provide an automation system for a universal crane tower, which provides control in real time.

Therefore, bearing in mind the problems referred to and for the purpose of overcoming them and seeking to meet the objectives mentioned above an improved crane was developed, the objective of this patent, which substantially consists of providing a mobile counterweight for the crane which moves along the counterjib using another trolley and this moves in function of the weight and position of the load on the jib and seeks to totally cancel the momentum resulting on the tower by the movement of the load, and the load movement along the jib is controlled by the operator and the counterweight movement along the counterjib is made simultaneously, synchronized and automatically with the movement of the load, controlled in real time by an automated computerized system.

This method of crane construction solves the problems put forth, because it is only possible to totally cancel the tower momentum by moving the counterweight, because its weight is constant.

This will result in an increase in the safety factor, increase the operational load limit, construction of taller cranes and a prolonged working life, among others.

The attached drawings refer to the improvement of a crane and counterweight control process on a crane in real time, the objective of this patent, in which:

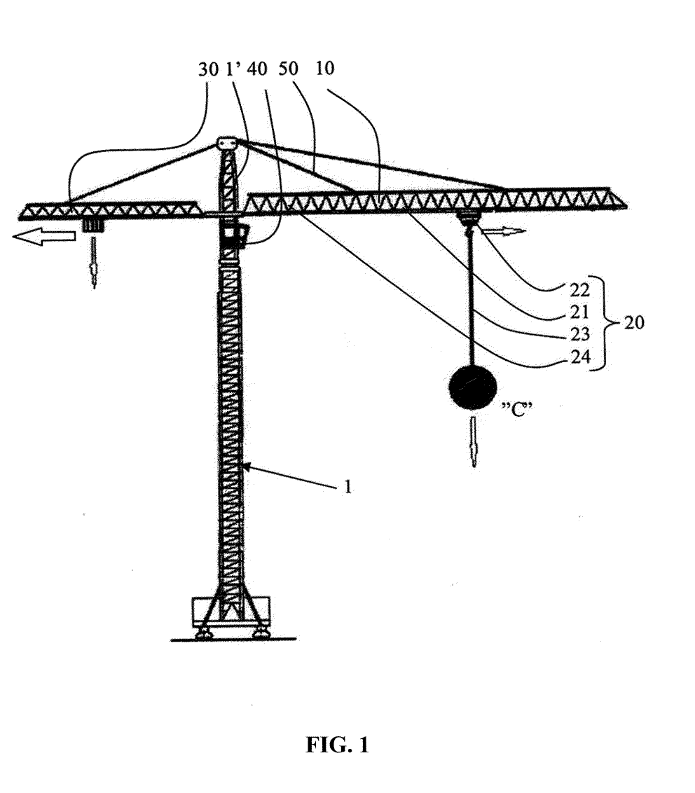

FIG. 1 shows a general schematic view of the crane with the load going over an intermediate position on the jib in the direction of its farthest point, indicated by arrows and the counterweight going over the corresponding intermediate position on the counterjib, indicated by arrows, which cancels the total resulting, momentum on the tower and the usual crane parts are indicated in the figure with numerical references; and

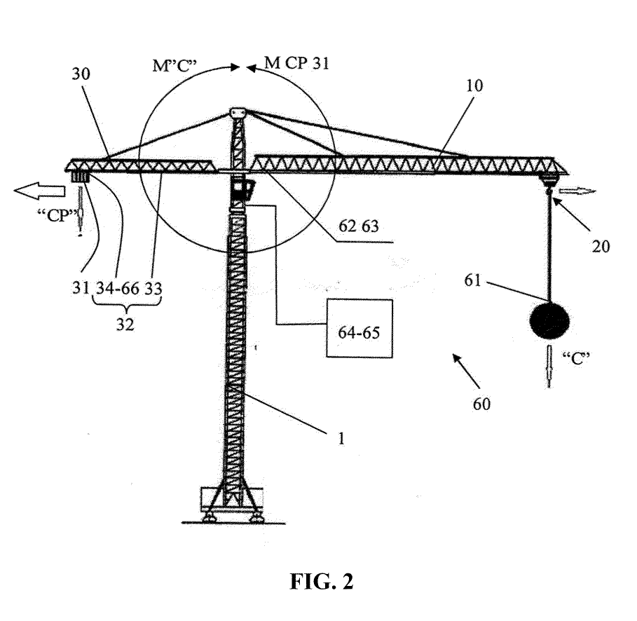

FIG. 2 shows the same figure as above, but with the load situated at the jib end and the counterweight in the corresponding counterjib end, which totally cancels the maximum momentum on the tower and parts substantially included in the crane for improvement are indicated in the figure with numerical references:

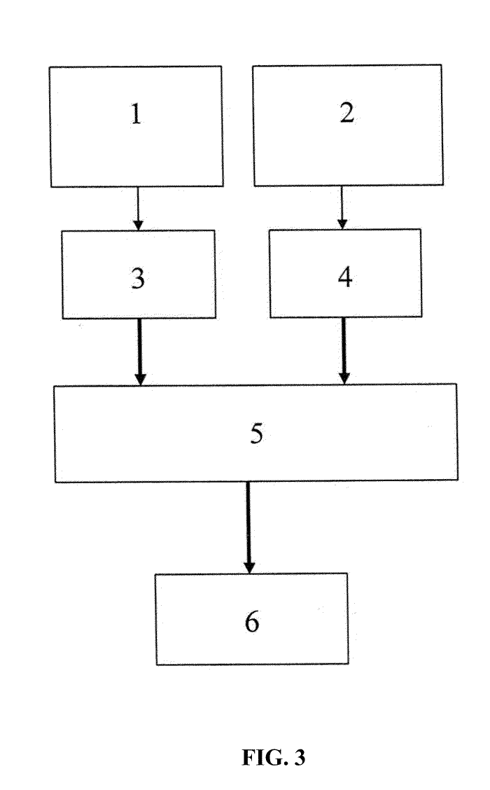

FIG. 3 shows a flowchart of the control process stages;

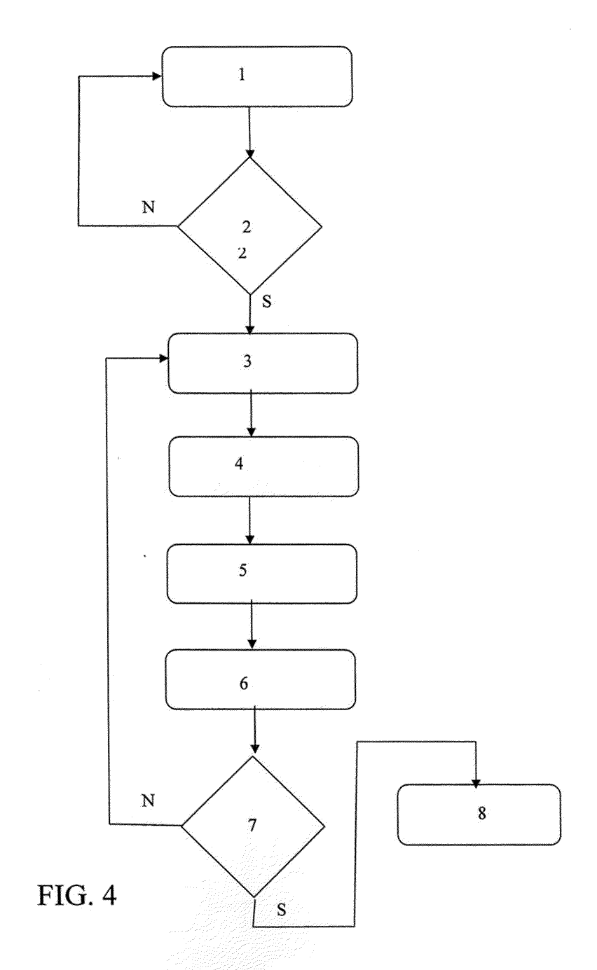

FIG. 4 shows a process function flowchart relative to load “C” maneuvered by the crane controlled by the operator; and

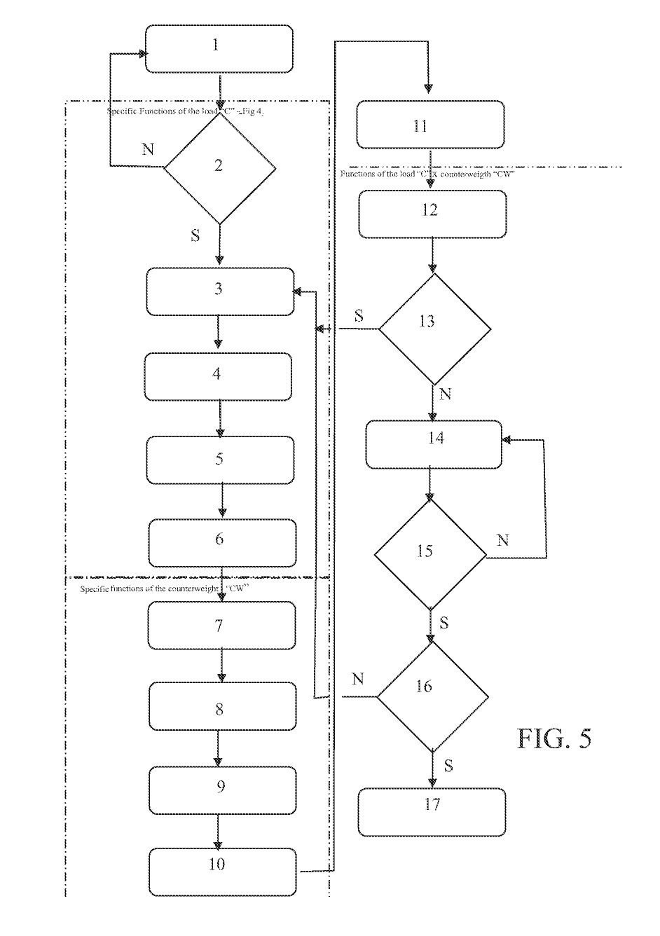

FIG. 5 shows a function process flowchart relative to the crane counterweight, in function of load “C” and controlled automatically by the system.

In conformity with what is shown in the figures related to above, the crane, the objective of this patent, essentially consists of: a tower 1, whose base is securely assembled on a surface or assembled on a mobile base or assembled with any method normally used; a horizontal jib 10 near the upper end of the tower 1 and on which is assembled trolley system 20, made from: rails 21 assembled along the jib 10; a trolley 22, assembled and moving on the rails; a cable 23 supported by trolley 22, hanging from below and whose lower end supports load “C” maneuvered by the crane; by a crane group 24 associated with the trolley and cable group 22-23, which elevates load “C” and moves the trolley group 22, load “C” along the jib 10 toward or away from the tower; this crane is also formed by a horizontal counterjib 30 assembled at the top of the tower 1, opposite the jib 10; a counterweight 31 (FIG. 2), placed on the counterjib 30 and also part of the crane are the usual components, such as the operator cab 40, situated on the tower; the tower end 1′ extends above the jibs, cables 50 support the jibs, assembled on them and on the tower end 1′ and other usual places.

In this improvement. instead of a fixed counterweight 31 as normally occurs a momentum cancelling system of load “C” is provided on tower 1, essentially consisting of, (FIG. 2):
A mobile counterweight, assembled on a respective trolley 32 system assembled on the counterjib 30 and this can move toward or away from the tower 1 in function of the weight and position of load “C” in relation to this last one to totally cancel the resulting momentum in the tower generated by the movement of load “C”; and
Automation system 60 of a universal tower crane (crane), which implements a counterweight control process on a crane in real time, which controls the mobile counterweight 31 movement on the counterjib 30 in function of the mass and position of load “C” on jib 10, seeking to cancel the total momentum resulting on the tower by the movement of load “C”; this system 60 substantially consists of hardware and software made up of, at least: sensor 61 to acquire information of the weight of load “C”, sensor 62 to acquire information of the position of load “C” on the jib 10, sensor 63 to acquire information of the position of the counterweight 31 on the counterjib 30, installed on tower 1 or optionally on the actual counterweight trolley 32; CPU containing the database 64 to store the data used by the system to make calculations, such as extensions of jib 10 and counterjib 30, counterweight weight 31, maximum momentum supported by tower 1, maximum load “C” supported by the crane and others and a data processing method 65 which receives the information acquired by the sensors; calculating the momentum generated by load “C” position at each instant of movement, momentum generated by the counterweight position 31 in each instant of movement and determine the total resulting momentum of the tower and in function of this generate a control signal to continue or not the counterweight 31 movement on the counterjib 30 simultaneously and synchronized with the movement of load “C”; and actuator devices 66 which receive control signals and automatically move the trolley system 32 of counterweight 31.

In detail, the mobile counterweight 31 can be just a mobile block assembled on a trolley and this on a rail of the trolley system 32 assembled on the counterjib [30] 10 or optionally, consisting of more than one mobile block, which have different weights and assembled on respective trolleys and rails. A greater quantity of mobile blocks provides greater load control, because the movement of a smaller weight will reduce the momentum in a more precise way than a larger weight, if the load is very high it will need the movement of a heavier counterweight. Therefore the counterweight 31 in the form of various blocks brings greater precision to the system.

The trolley 32 system for counterweight 31 movement consists of: a rail system 33, which can use a cog rail, using cables or similar systems assembled on the counterjib 30; a trolley 34 assembled on a rail 33 and on which is assembled the counterweight 31, arranged to guide this along the counterjib 30, in which the position is adjusted by the Automation system 60, which provides control in real time of the counterweight position 31 on the counterjib 30 in function of the weight and position of load “C” assembled on trolley 22 which moves on jib 10, controlled by the tower crane operator.

The sensor devices consist of electrical sensors which make constant useful readings of the system substantially consisting of two fundamental types: weight/dynamometer or stress/strain sensors 61 and movement sensors 62, 63.

The first, weight/dynamometer or stress/strain sensors 61, are responsible for obtaining the weight value or weight [mass and gravitational force] of load “C” and the acquisition of this value can be made in various forms such as, for example, the use of strain sensors based on the strain of some material that is supporting the load, such as the cable. Optionally, robust weight sensors can be provided and so are suitable for the use, which are easy to install and give an electrical signal corresponding to the weight value, which can be installed between the load “C” and cable 23, for example, a “RON 2501-Shackle Type” sensor, or similar.

The distances of load “C” and the counterweight 31 from the tower center 1 for momentum calculation, can be measured by various methods using electrical sensors. So, the movement sensors 63 can be any type which makes such measurements, such as: potentiometer sensors, in which the behavior of the monitored object corresponds to the potentiometer cursor, varying the electrical resistance, with this variation the position/movement is obtained or the same effect can be obtained with capacitive sensors, in which the movement of the object makes a capacitor plates move together or move away from each other and the capacitance reading gives the position of the object or the use of a Linear Variable Differential Transformer too, where the object whose position is monitored moves the core of a three coil transformer and codified sensors can be used, where the object moves over a surface marked with codes and a transducer reads these codes indicating its position. However, with the intention of using robust sensors and easy to install in structure such as a tower crane, the movement sensor 63 for the counterweight 31 is preferably, a cable movement sensor, in which the sensor is installed in the tower 1 center and the cable end in the trolley 32 of the counterweight 31 or, vice versa, the sensor is installed in the trolley 32 and the cable end in the tower 1 center, in a way that the cable, movement of the trolley and counterweight 31 are parallel to the counterjib 30. Such a movement sensor construction is also used for sensor 62 which measures the distance of load “C” from the tower 1 center, and the sensor installed in the tower 1 center and the cable end in the load trolley 22 which contains the load “C” or vice versa, the sensor installed in the distribution trolley 22 and the cable end in the tower 1 center. So, with the unwinding of the cable of the trolley 22 of load “C” and the cable of the counterweight trolley 31 the sensor 62,63 detects this unwinding and has the value of the position/movement to be processed.

The data processing devices 65 of system 60 planned are essentially a microcontroller and a computer program dedicated and associated to receive and process the signals supplied by the sensors 61, 62, 63 and generate control signals to control in real time the counterweight 31 trolley system 32. In the microcontroller memory or in an external memory in some other processing unit is stored software which contains the computer program dedicated to constantly making calculations relative to the momentum of load “C”, momentum of counterweight 31 and the total momentum on the tower 1 and from the result generate an output control signal which controls the counterweight 31 movement on the counterjib 30 in real time and simultaneously and in synchronism with the movement of load “C” on jib 10. Due to safety reasons and from the same information collected and processed by the system, it is also planned that alarm signals are supplied, preferably illuminated to warn the crane operator when the total tower 1 momentum is higher than the planned nominal value, despite the controlled system conforming to the invention foreseen, increases even more the crane loading capacity, also bringing greater safety for the crane/operator and also a longer working life by removing cyclic forces.

The counterweight control process on a crane in real time, also the objective of this patent, which controls the crane as described above, therefore substantially consists of the stages of:

1)—Creating a database containing at least information relative to: extensions of the jib 10 and the counterjib 30, counterweight weight 31, maximum momentum supported by the tower 1, maximum load “C” supported by the crane and others:

2)—Acquisition of data related to: the load “C” weight maneuvered by the crane; the load “C” position on the jib 10 and the counterweight 31 position on the counterjib 30:

3)—Processing data acquired of the weight and position of load “C” to determine the momentum of load “C”’, momentum “C” on the tower 1 for each instant of movement of load “C”; processing data acquired relative to the counterweight 31 position on the counterjib 30 and the data stored of the counterweight 31 to determine the momentum of counterweight 31, momentum CP 31 to determine the total resulting momentum on tower 1; and

4)—In function of the total resulting momentum on the tower 1 generate a control signal to continue or not the counterweight 31 movement, to cancel or maintain the total resulting momentum on the tower 1 cancelled or reduce the total resulting momentum on the tower 1 inside the tolerance band of the tower and/or system.

FIG. 3 refers to a process flowchart and on this block 1 refers to the parameters of load “C” which are part of the process, weight and movement: block 2 refers to the counterweight 31 parameter, which is part of the process, weight and movement; block 3 refers to the data acquisition stage (sensor) of weight and movement of load “C”; block 4 refers to data acquisition (sensor) of weight and movement of counterweight 31; block 5 refers to the processing (microcontroller) of the data acquired by the sensors in real time or filed in the memory; and block 6 refers to the counterweight 31 control.

The flowcharts of the functions in FIGS. 4, 5 show in a generalized line the system software functions to substantially implement the counterweight control process in a crane in real time in function of the load movement on a crane due to operator control.

FIG. 4 refers to the functions relative to load “C” moving on the jib 10 due to operator control, made in real time:
Start (block 1)
Is load “C” moving on the jib 10 due to operator control? (block 2). NO) go to block 1. YES go to block 3;
Measure load “C” weight in real time or fetch load “C” weight measured earlier and recorded in the memory (block 3);
Measure distance (lever arm) of load “C” from the tower 1 in real time (block 4) for each instant of movement;
Calculate the momentum of the load “C” on the tower 1 (load “C” distance from tower 1×load “C”=momentum “C”) in real time for each instant of load “C” movement (block 5);
Record momentum “C” of load “C” on the tower 1 in real time, for each instant of movement (block 6);
Has load “C” arrived at the desired point on jib 10 or has it reached the jib 10 end? (block 7). No go to block 3. YES go to (block 8);
End (block 8).

FIG. 5 refers to the functions relative to the counterweight “CP” automatically moving on the counterjib 30 in function of momentum “C” made in real time, for each instant of movement of load “C” and counterweight “CP”.
Start (block 1)
Do the functions relative to load “C” substantially conform to that shown in the flowchart of FIG. 4:—Is load “C” moving? (block 2). NO go to block 1. YES go to block 3;
Measure load “C” weight in real time or fetch load “C” weight measured earlier and recorded in the memory (block 3);
Measure distance (lever arm) of load “C” from the tower 1 (block 4) in real time for each instant of movement of load “C”;
Calculate the momentum of the load “C” on the tower 1 (load “C” distance from tower 1×load “C”=momentum “C”) (block 5) in real time for each instant of load “C” movement;
Record momentum “C” (block 6) in real time, for each instant of load “C” movement;
Make specific functions of counterweight “CP” in function of the movement of load “C” on jib 10:—Automatically move the counterweight CP on the counterjib 30 in function of the movement of load “C” (block 7);
Measure the counterweight weight “CP”’ in real time or fetch the weight from the memory (block 8);
Measure distance of the counterweight “CP” in relation to the tower 1 center (lever arm) in real time for each instant of the counterweight “CP” movement (block 9);
Calculate the momentum of the counterweight “CP” on the tower 1 (“CP” distance from tower center×load “CP”=momentum CP) in real time for each instant of the counterweight “CP” movement (block 10):
Record momentum “CP” in real time, for each instant of the counterweight “CP” movement (block 11):
Functions interpolating information of load “C” moving on the jib due to operator command and information of the counterweight “CP” moving on the counterjib automatically in function of information of load “C”: Compare momentum “C”×momentum “CP” (block 12);
Is momentum “C” equal to (=) the momentum “CP” or is momentum “C” different from (≠) the momentum “CP” inside the tolerance band accepted by the system? (block 13). NO go to block 14. YES go to block 3;
Move or stop the counterweight “CP” and/or change the counterweight “CP” speed or change the direction of movement of the counterweight “CP” and/or make other maneuvers to equalize the momentums “C” and “CP” or reduce the differences in the momentums “C” and “CP” until the system tolerance level is reached (block 14);
Is momentum “C” equal to (=) the momentum “CP” or is momentum “C” different from (≠) the momentum “CP” inside the tolerance band accepted by the system? (block 15). NO go to block 14. YES go to block 16;
Load “C” arrived at the point desired on jib 10 or has reached the jib 10 end?(block 16). NO go to block 3. YES go to (block 17);
End (block 17).

Within the basic construction described above, the improvement of the crane and counterweight control process in a crane in real time, the objective of this patent, can have modifications in terms of materials, dimensions, constructive details and/or functional configuration and/or in terms of stages and process parameters without departing from the extent of the requested protection.

Within this, a counterweight control process can be provided on a crane in real time, in which the system totally and automatically interferes with the counterweight 31 movement on the counterjib 30 and simultaneously, automatically and partially in the movement of the Load “C” on jib 10 controlled by the operator. For example, load “C” could be stopped and/or have a speed and/or direction of movement changed and/or undergo other simultaneous dynamic interferences to the counterweight 31, which favor the total cancelling of the momentum of tower 1 or reduce the tower 1 total momentum inside the tower tolerance band and/or system.

1) “CRANE IMPROVEMENT”, essentially consisting of: a tower (1); a horizontal jib (10) assembled near the upper end of the tower (1); a trolley system (20) assembled on the jib (10); a load “C” assembled on the trolley (22) of the trolley system (20); a horizontal counterjib (30) assembled at the tower top (1), opposite the jib (20) [10], a counterweight (31) on the counterjib (30); and others characterized by:
A mobile counterweight (31) assembled on a respective trolley system (32) assembled on a counterjib (30) and that can be moved toward or away from the tower (1) in function of the weight and position of load “C” in relation to the tower (1) to totally cancel the resulting momentum in the tower generated by the movement of load “C”; and
Automation system (60) of a universal tower crane (crane), which implements a counterweight control process on a crane in real time, which controls the mobile counterweight (31) movement on the counterjib (30) in function of the mass and position of load “C” on jib (10), seeking to cancel the total momentum resulting on the tower by the movement of load “C”.

2) “CRANE IMPROVEMENT” in accordance with claim 1, consisting of an automation system (60) which is substantially made up of hardware and software, characterized by, at least: sensor (61) to acquire information of the weight of load “C”, sensor (62) to acquire information of the position of load “C” on the jib (10), sensor (63) to acquire information of the position of the counterweight (31) on the counterjib (30); CPU containing the database (64) to store useful data, such as extensions of jib (10) and counterjib (30), counterweight weight (31), maximum momentum supported by tower (1), maximum load “C” supported by the crane and others and a data processing method (65) which receives the information acquired;
calculating the momentum generated by load “C” position at each instant of movement, momentum generated by the counterweight position (31) in each instant of movement and determine the total resulting momentum of the tower and in function of this generate a control signal to continue or not the counterweight (31) movement on the counterjib (30) simultaneously and synchronized with the movement of load “C”; and actuator devices (66) which receive control signals and automatically move the trolley system (32) of counterweight (31).

3) “CRANE IMPROVEMENT” in accordance with claim 1 or 2, characterized by a mobile counterweight (31), a mobile block assembled on a trolley and this on a rail of the trolley system (32) assembled on the counterjib (10) or optionally, consisting of more than one mobile block, which have different weights and assembled on respective trolleys and rails of the trolley system (32).

4) “CRANE IMPROVEMENT” in accordance with claim 1 or 2, characterized by a trolley (32) system for counterweight (31) movement which consists of: a rail system (33), which can be a cog rail, using cables or similar systems assembled on the counterjib (30); a trolley (34) assembled on a rail (33) and on which is assembled the counterweight (31), arranged to guide this along the counterjib (30), in which the position is adjusted by the Automation system (60).

5) “CRANE IMPROVEMENT” in accordance with claim 1 or 2, characterized by electrical sensors arranged to make constant readings and substantially consist of two fundamental types: weight/dynamometer or stress/strain sensors (61) which acquire information on the mass or weight of the load “C” and movement sensors (62), (63) which acquire information on the load “C” position and the counterweight (31) on the jib (10) and counterjib (30) respectively.

6) “CRANE IMPROVEMENT” in accordance with claim 5, characterized by weight/dynamometer or stress/strain sensors (61) which can be a strain sensor which detects the strain of some material which supports the load, such as a cable or weight sensor.

7) “CRANE IMPROVEMENT” in accordance with claim 5, characterized by movement sensors (62), (63) which detect the load “C” positions on the jib (10) and counterweight (31) on the counterjib (30) are preferably cable movement sensors, installed on the tower (1) center and at the ends of the cables on the counterweight trolley (31) and trolley (22) of the load “C” or vice versa, sensors installed on the counterweight (31) trolley and trolley (22) and the ends of the cables on the tower center (1), in a way that the movement cable of the trolley and counterweight (31) and trolley (22) load “C” are parallel to the counterjib (30) and jib (10) and unwinding of them are detected by sensors (62), (63) with which is acquired the value of the position/movement of the load “C” and counterweight (31) to be processed.

8) “CRANE IMPROVEMENT” in accordance with claim 5, characterized by movement sensors (62), (63) which detect the load “C’ positions on the jib (10) and counterweight (31) on the counterjib (30) are potentiometer sensors or capacitive sensors or sensor consisting of a Linear Variable Differential Transformer, LVDT or codified sensors or other similar types.

9) “CRANE IMPROVEMENT” in accordance with claims 1 and 2, characterized by data processing devices (65) consisting of a microcontroller or any other similar processing unit and computer program dedicated and associated which receives and processes signals supplied by sensors (61), (62), (63) and generate control signals to control in real time the trolley system (32) of the counterweight (31).

10) “CONTROL PROCESS OF A COUNTERWEIGHT IN A CRANE IN REAL TIME”, which controls the crane of claims 1 to 9, characterized substantially by the stages of:
1)—Creating a database containing at least information relative to: extensions of the jib (10) and the counterjib (30), counterweight weight (31), maximum momentum supported by the tower (1), maximum load “C” supported by the crane and others;
2)—Acquisition of data related to: the load “C” weight maneuvered by the crane; the load “C” position on the jib (10) and the counterweight (31) position on the counterjib (30):
3)—Processing data acquired of the weight and position of load “C” to determine the momentum of load “C”, momentum “C” on the tower (1) for each instant of movement of load “C”; processing data acquired relative to the counterweight (31) position on the counterjib (30) and the counterweight (31) data stored 31 to determine the momentum of counterweight (31), momentum CP (31) to determine the total resulting momentum on tower (1): and
4)—In function of the total resulting momentum on the tower (1) generate a control signal to interfere in the counterweight (31) movement, to cancel or maintain the total resulting momentum on the tower (1) cancelled or reduce the total resulting momentum on the tower (1) inside the tolerance band of the tower and/or system.

11) “CONTROL PROCESS OF A COUNTERWEIGHT IN A CRANE IN REAL TIME”, in accordance with claim 10 characterized by software dedicated to controlling the counterweight in a crane in real time in function of load movement on a crane made by operator control, this software carries out in real time functions relative to load “C” moving on the jib (10) by operator control. substantially consisting of:
Start (block 1),
Is load “C” moving on the jib due to operator control? (block 2). NO go to block 1. YES go to block 3;
Measure load “C” weight in real time or fetch load “C” weight measured earlier and recorded in the memory (block 3);
Measure distance (lever arm) of load “C” from the tower center in real time (block 4) for each instant of movement:
Calculate the momentum of the load “C” on the tower center (load “C” distance from tower 1×load “C”=momentum “C”) in real time for each instant of load “C” movement (block 5);
Record momentum “C” of load “C” on the tower center in real time, for each instant of movement (block 6);
Load “C” arrived at the point desired on jib or has reached the jib 10 end? (block 7). NO go to block 3. YES go to (block 8);
End (block 8).

12) “CONTROL PROCESS OF A COUNTERWEIGHT IN A CRANE IN REAL TIME”, in accordance with claim 10 or 11 characterized by software dedicated to carrying out functions relative to the counterweight “CP” automatically moving on the counterjib in function of momentum “C” made in real time, for each instant of movement of load “C” and counterweight “CP” consisting of:
Start (block 1):
Functions relative to load “C” moving on the jib due to operator control: Is load “C” moving? block 2). NO go to block 1. YES go to block 3;
Measure load “C” weight in real time or fetch load “C” weight measured earlier and recorded in the memory (block 3);
Measure distance (lever arm) of load “C” from the tower 1 (block 4) in real time for each instant of movement of load “C”;
Calculate the momentum of the load “C” on the tower 1 (load “C” distance from tower 1×load “C”=momentum “C”) (block 5) in real time for each instance of load “C” movement;
Record momentum “C” (block 6) in real time, for each instance of load “C” movement;
Make specific functions of counterweight “CP” in function of the movement of load “C” on jib:—Automatically move the counterweight CP on the counterjib 30 in function of the movement of load “C” on the jib (10) (block 7):
Measure the counterweight weight “CP” in real time or fetch the weight from the memory (block 8);
Measure distance of the counterweight “CP” in relation to the tower 1 center (lever arm) in real time for each instant of the counterweight “CP” movement (block 9);
Calculate the momentum of the counterweight “CP” on the tower 1 (“C” distance from tower center×load “CP”=momentum CP) in real time for each instant of the counterweight “CP” movement (block 10);
Record momentum “CP” in real time, for each instant of the counterweight “CP” movement (block 11);
Functions interpolating information of load “C” moving on the jib due to operator control and information of the counterweight “CP” moving on the counterjib automatically in function of information of load “C”: Compare momentum “C”×momentum “CP” (block 12);
Is momentum “C” equal to (=) the momentum “CP” or is momentum “C” different from (≠) the momentum “CP” inside the tolerance band accepted by the system? (block 15). NO go to block 14. YES go to block 16;
Load “C” arrived at the point desired on jib 10 or has reached the jib 10 end? (block 16). NO go to block 3. YES go to (block 17);
End (block 17).

13) “CONTROL PROCESS OF A COUNTERWEIGHT IN A CRANE IN REAL TIME”, in accordance with claim 10 or 11 or 12 characterized by a system, optionally, that can totally and automatically interfere with the counterweight (31) movement on the counterjib (30) and simultaneously, automatically and partially in the movement of the jib (10) controlled by the operator.

14) “CONTROL PROCESS OF A COUNTERWEIGHT IN A CRANE IN REAL TIME”, in accordance with claim 13 characterized by load “C” that can be stopped and/or have a speed and/or direction of movement changed and/or undergo other simultaneous dynamic interferences to the counterweight (31), which favor the total cancelling of the momentum of tower (1) or reduce the tower (1) total momentum inside the tower tolerance band and/or system.
